(19) United States
(12) Patent Application Publication
(10) Pub. No.: US 2025/0291404 A1
(43) Pub. Date: Sep. 18, 2025

(54) SEMICONDUCTOR DEVICE

(71) Applicant: Canon Kabushiki Kaisha, Tokyo (JP)

(72) Inventor: EIKI AOYAMA, Chiba (JP)

(21) Appl. No.: 19/059,478

(22) Filed: Feb. 21, 2025

(30) Foreign Application Priority Data
Mar. 18, 2024 (JP) 2024-042122

(51) Int. Cl. G06F 1/3237; G06F 1/3287

(52) U.S. Cl. CPC G06F 1/3237; G06F 1/3287

(57) ABSTRACT

A semiconductor device includes processing circuits; a stop circuit determination unit determining a first processing circuit an operation of which is to be stopped from among the processing circuits, and a stop method determination unit determining a stop method for the operation in the first processing circuit to be either a first stop method including power shut off or a second stop method not including power shut off, based on circuit information of each of the first processing circuit and a second processing circuit different from the first processing circuit among the processing circuits. The stop method determination unit determines the stop method such that a load impedance of a processing circuit, which is in a stop state at a same time due to the first stop method, among the processing circuits, as seen from a power supply wiring side is equal to or greater than a predetermined impedance.

### BACKGROUND OF THE INVENTION

### Field of the Invention

The present invention relates to a semiconductor device.

### Description of the Related Art

Japanese Patent Application Laid-Open No. 2016-119003 (Patent Document 1) discloses a semiconductor integrated circuit capable of low power consumption control. The semiconductor integrated circuit of Patent Document 1 includes a clock gating circuit that controls the presence or absence of supply of a clock signal to a circuit such as a processor core, and a power switch that controls the presence or absence of supply of a power supply voltage to the circuit. Patent Document 1 proposes a technique for achieving both low power consumption and improvement in processing performance by applying clock gating instead of power shut off to a circuit having a high operation stop frequency.

Japanese Patent Application Laid-Open No. 2021-139836 (Patent Document 2) discloses a ranging sensor including a plurality of signal processing modules capable of independently controlling power supply.

### SUMMARY OF THE INVENTION

According to one disclosure of the present specification, there is provided a semiconductor device including a plurality of processing circuits, a stop circuit determination unit configured to determine a first processing circuit an operation of which is to be stopped from among the plurality of processing circuits, and a stop method determination unit configured to determine a stop method for the operation in the first processing circuit to be either a first stop method including power shut off or a second stop method not including power shut off, based on circuit information of each of the first processing circuit and a second processing circuit different from the first processing circuit among the plurality of processing circuits. The stop method determination unit determines the stop method such that a load impedance of a processing circuit, which is in a stop state at a same time due to the first stop method, among the plurality of processing circuits, as seen from a power supply wiring side is equal to or greater than a predetermined impedance.

According to one disclosure of the present specification, there is provided a semiconductor device including a plurality of processing circuits; a stop circuit determination unit configured to determine a first processing circuit an operation of which is to be stopped from among the plurality of processing circuits, and a stop method determination configured to determine a stop method for the operation in the first processing circuit to be either a first stop method including power shut off or a second stop method not including power shut off, based on circuit information of each of the first processing circuit and a second processing circuit different from the first processing circuit among the plurality of processing circuits. The stop method determination unit determines the stop method such that the number of processing circuits, which are in a stop state at a same time due to the first stop method, among the plurality of processing circuits is equal to or less than a threshold.

Further features of the present invention will become apparent from the following description of exemplary embodiments with reference to the attached drawings.

### BRIEF DESCRIPTION OF THE DRAWINGS

FIG. 1 is a functional block diagram of a semiconductor device according to a first embodiment.

FIG. 2 is a schematic plan view illustrating physical arrangement on a semiconductor substrate in the semiconductor device according to the first embodiment.

FIG. 3 is a table illustrating a temporal change of a state of a processing circuit in the semiconductor device according to the first embodiment.

FIG. 4 is a schematic plan view illustrating the temporal change of the state of the processing circuit in the semiconductor device according to the first embodiment.

FIG. 5 is a schematic plan view illustrating a temporal change of a state of a processing circuit in a semiconductor device according to a comparative example.

FIG. 6 is a schematic plan view illustrating the physical arrangement on the semiconductor substrate in the semiconductor device according to the first embodiment.

FIG. 7 is a functional block diagram of a semiconductor device according to a modification of the first embodiment.

FIG. 8 is a functional block diagram of a semiconductor device according to a modification of the first embodiment.

FIG. 9 is a block diagram of a semiconductor device according to a second embodiment.

FIG. 10 is a schematic diagram illustrating a temporal change of a state of a processing circuit in the semiconductor device according to the second embodiment.

FIG. 11 is a block diagram of a semiconductor device according to a third embodiment.

FIG. 12 is a schematic diagram illustrating a temporal change of a state of a processing circuit in a semiconductor device according to the third embodiment.

FIG. 13 is a block diagram of equipment according to a fourth embodiment.

FIGS. 14A and 14B are block diagrams of equipment according to a fifth embodiment.

### DESCRIPTION OF THE EMBODIMENTS

In a semiconductor device having a plurality of processing circuits in which power shut off is to be performed as in Patent Document 1 and Patent Document 2, it can be required to more appropriately recover from a power shut-off state.

The following disclosure relates to a semiconductor device that can more appropriately recover from the power shut-off state.

Hereinafter, embodiments of the present invention will be described with reference to the drawings. Identical or corresponding elements throughout a plurality of drawings are denoted by common reference numerals, and the description thereof may be omitted or simplified.

### First Embodiment

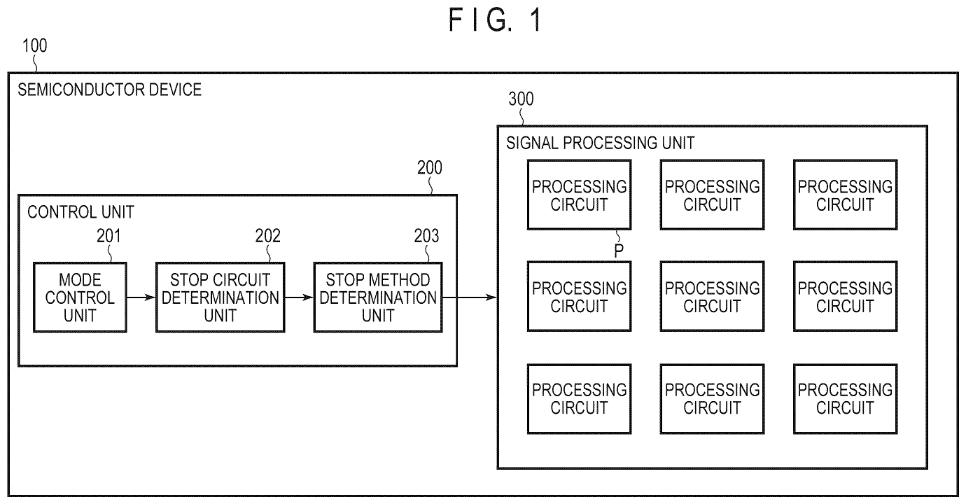

A configuration of a semiconductor device 100 according to the present embodiment will be described. FIG. 1 is a functional block diagram of the semiconductor device 100 according to the present embodiment. The semiconductor device 100 is, for example, a semiconductor integrated circuit formed on a semiconductor substrate. The semiconductor device 100 includes a control unit 200 and a signal processing unit 300.

The signal processing unit 300 is a signal processing circuit that processes an input signal and outputs the result. The signal processing unit 300 includes a plurality of processing circuits P. Each of the plurality of processing circuits P processes the signal input to the signal processing unit 300. The circuit configuration of each of the plurality of processing circuits P may be the same or different. The type of the signal processed by the signal processing unit 300 is not particularly limited, but for example, the signal processing unit 300 can be an image processing circuit that processes a pixel signal output from a photoelectric conversion element. Although nine processing circuits P are illustrated in FIG. 1, the number and arrangement of the plurality of processing circuits P are not limited to those illustrated in FIG. 1.

The control unit 200 includes a mode control unit 201, a stop circuit determination unit 202, and a stop method determination unit 203. The control unit 200 is a control circuit that controls the operation of the semiconductor device 100. That is, the control unit 200 has a function of controlling an operation of signal processing in the signal processing unit 300.

The mode control unit 201 outputs, to the stop circuit determination unit 202, operation mode information indicating an operation mode of the semiconductor device 100. This operation mode can include a setting related to power control in the semiconductor device 100.

The stop circuit determination unit 202 determines the processing circuit P (first processing circuit) the operation of which is to be stopped from among the plurality of processing circuits P, based on the operation mode information output from the mode control unit 201. Then, the stop circuit determination unit 202 outputs, to the stop method determination unit 203, information indicating the processing circuit P the operation of which is to be stopped.

The stop method determination unit 203 determines an operation stop method for the processing circuit P indicated in the information input from the stop circuit determination unit 202. Then, the stop method determination unit 203 outputs, to the processing circuit P to be stopped, a control signal for stopping an operation by the determined stop method. In addition, the stop method determination unit 203 outputs a control signal for recovering the processing circuit P the operation of which has been stopped.

The candidates of the stop method to be determined by the stop method determination unit 203 include at least a first stop method including power shut off (PSO) and a second stop method not including power shut off. In the present embodiment, the second stop method is clock gating (CG). When determining the stop method for a certain processing circuit P, the stop method determination unit 203 determines the stop method with reference to not only the circuit information of the target processing circuit P (first processing circuit) but also the circuit information of another processing circuit P (second processing circuit). The circuit information can be information regarding the processing circuit P, such as information indicating the arrangement of circuits including the processing circuit P, and information indicating whether or not the processing circuit Pis in a stop state due to power shut off. That is, the circuit information may be information that does not change over time, such as the arrangement of circuits, or may be information that changes over time, such as a stop state of the processing circuit P.

Note that the power shut off is a method of reducing power consumption by shutting off the power supplied to the target processing circuit P. On the other hand, the clock gating is a method of reducing power consumption by gating a clock signal input to the target processing circuit P and stopping a change in potential. In the clock gating, the power supply itself to the processing circuit P is continued, so that the power consumption of the processing circuit P on which the clock gating is performed is larger than the power consumption of the processing circuit P on which the power shut off is performed. Therefore, the power consumption reduction effect of the power shut off is higher than the power consumption reduction effect of the clock gating. On the other hand, the recovery time of the processing circuit P on which the clock gating has been performed is shorter than the recovery time of the processing circuit P on which the power shut off has been performed.

When the processing circuit P recovers from the power shut-off state, a power supply voltage in the processing circuit P may not reach a predetermined voltage value within a predetermined time, so that a malfunction of the circuit occurs. In addition, when the processing circuit P recovers from the power shut-off state, an inrush current generated by supplying a voltage to the processing circuit P may serve as a noise source, so that the malfunction of the circuit occurs. As described above, in the method of stopping the processing circuit P by the power shut off, the malfunction of the circuit may occur at the time of recovery from the power shut-off state. In the present embodiment, a method of stopping the processing circuit P capable of reducing the occurrence of the malfunction of the circuit will be described.

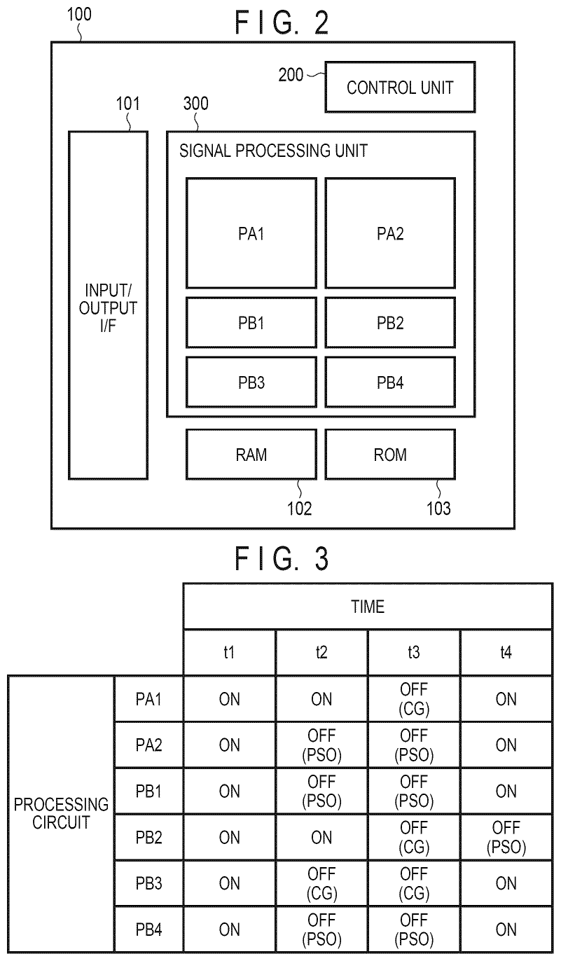

FIG. 2 is a schematic plan view illustrating physical arrangement on the semiconductor substrate in the semiconductor device 100 according to the present embodiment. FIG. 2 schematically illustrates the physical arrangement of elements in plan view with respect to the semiconductor substrate. The semiconductor device 100 includes an input/output interface (I/F) 101, a random access memory (RAM) 102, and a read only memory (ROM) 103 in addition to the control unit 200 and the signal processing unit 300 described above. The input/output I/F 101 is a circuit that inputs and outputs a signal to and from the semiconductor device 100. The RAM 102 is a volatile memory that temporarily stores information to be processed. The ROM 103 is a nonvolatile memory that holds information necessary for processing in advance.

The signal processing unit 300 includes a plurality of processing circuits PA1, PA2, PB1, PB2, PB3, and PB4. The two processing circuits PA1 and PA2 are processing circuits of the same type. In addition, the four processing circuits PB1, PB2, PB3, and PB4 are the same type of processing circuits. On the other hand, the processing circuits PA1 and PA2 are a different type of processing circuits from the processing circuits PB1, PB2, PB3, and PB4. The processing circuits PA1 and PA2 are different from the processing circuits PB1, PB2, PB3, and PB4 in the capacitance of the power supply wiring.

The time required for recovery from the power shut-off state depends on a load impedance in each processing circuit as seen from a power supply wiring side. Here, each processing circuit including a semiconductor element such as a transistor is equivalently a capacitive load as seen from the power supply wiring side, and the load impedance is capacitive. Therefore, a delay time when the potential of the power supply wiring changes substantially depends on the capacitance acting on the power supply wiring of each processing circuit. When recovering from the power shut-off state, the potential of the power supply wiring of each processing circuit needs to reach a predetermined potential. Therefore, due to a difference in the capacitance of the power supply wiring, the processing circuits PA1 and PA2 are different from the processing circuits PB1, PB2, PB3, and PB4 in the time required for recovery from the power shut-off state.

For simplification of description, it is assumed that the capacitance of the power supply wiring of each of the processing circuits PA1 and PA2 is twice the capacitance of the power supply wiring of each of the processing circuits PB1, PB2, PB3, and PB4. Therefore, for example, assuming that the time required to recover the processing circuit PB1 from the power shut-off state is T, the time required to recover the processing circuit PA1 from the power shut-off state is 2T. In addition, assuming that T is the time required to recover the processing circuit PB1 from the power shut-off state, the time required to sequentially recover the processing circuit PA1 and the processing circuit PB1 from the power shut-off state is 3T.

The processing of recovering the plurality of processing circuits from the power shut-off state may be performed in parallel. Therefore, the time required for the plurality of processing circuits to sequentially recover from the power shut-off state may not be a simple sum of the time required to recover each processing circuit from the power shut-off state. However, when the time required to recover a single processing circuit from the power shut-off state is compared with the time required to recover the plurality of processing circuits from the power shut-off state in parallel, the latter is larger. In addition, in order to prevent an increase in the inrush current at the time of recovery from the power shut-off state, processing of sequentially recovering each processing circuit from the power shut-off state may be adopted. For simplification of description, hereinafter, it is assumed that the time required to recover the plurality of processing circuits from the power shut-off state is equal to a sum of the time required to recover each of the plurality of processing circuits from the power shut-off state.

FIG. 3 is a table illustrating temporal changes of the states of the processing circuits PA1 to PB4 in the semiconductor device 100 according to the present embodiment. FIG. 3 illustrates the states of the processing circuits PA1 to PB4 at each of times t1, t2, t3, and t4. “ON” in FIG. 3 indicates that the corresponding processing circuit is in an operating state. “OFF (PSO)” in FIG. 3 indicates that the corresponding processing circuit is in a stop state due to power shut off (first stop method). “OFF (CG)” in FIG. 3 indicates that the corresponding processing circuit is in a stop state due to clock gating (second stop method).

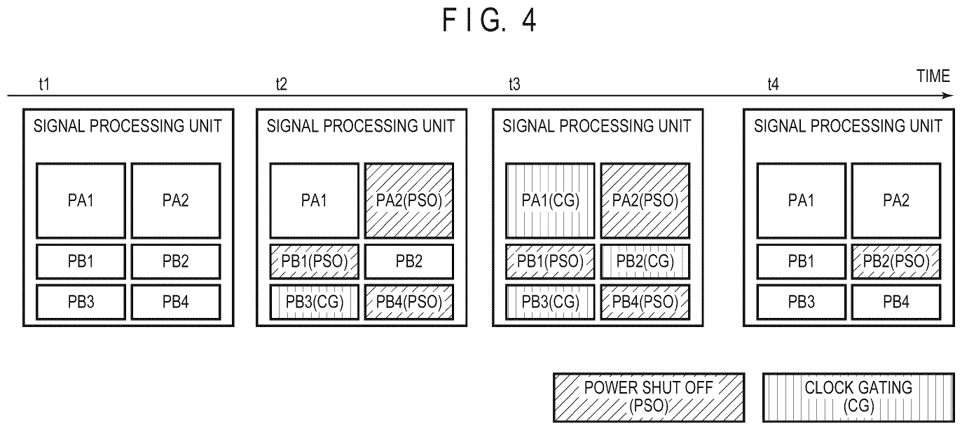

FIG. 4 is a schematic plan view illustrating the temporal changes of the states of the processing circuits PA1 to PB4 in the semiconductor device 100 according to the present embodiment. FIG. 4 schematically illustrates the temporal changes of the states of the processing circuits PA1 to PB4 at times t1, t2, t3, and t4 together with the planar physical arrangement thereof. Boxes indicating the processing circuits in the operating state are not hatched. As illustrated in the legend in the lower part of FIG. 4, two types of hatching are applied to the box indicating the processing circuit that is in the stop state due to either the power shut off or the clock gating.

In the present embodiment, an example will be described in which, assuming that the time required to recover the processing circuit PB1 from the power shut-off state is T, a processing circuit on which the power shut off is to be performed is selected such that the time required for recovery from the power shut-off state falls within 4T or less. As described above, the time required for the plurality of processing circuits to recover from the power shut-off state depends on the total value of the capacitances of the power supply wirings of the plurality of processing circuits. Therefore, a condition that the time required for recovery from the power shut-off state is equal to or less than a predetermined time corresponds to a condition that the total value of the capacitances of the power supply wirings of the processing circuits that are in the power shut-off state at the same time is equal to or less than a threshold. In addition, this condition more generally corresponds to a condition that the load impedance of the processing circuits, which are in the power shut-off state at the same time, as seen from the power supply wiring side is equal to or greater than a predetermined impedance.

The upper limit value of the time of 4T described above is set based on an allowable value of the recovery time in the circuit operation at the time of recovery from the power shut-off state and an allowable value of the inrush current. That is, in a case where the time required for recovery from the power shut-off state exceeds 4T, there is a case where the malfunction of the circuit occurs without ending the recovery operation within a predetermined time, or there is a case where noise due to the inrush current occurs to cause the malfunction of the circuit. In consideration of these possibilities, a processing circuit on which the power shut off is to be performed is selected such that the recovery time falls within 4T or less in the example illustrated in FIGS. 3 and 4. Since the recovery time is determined based on the states of the plurality of processing circuits, circuit information of the plurality of processing circuits is necessary for selecting the processing circuit. The recovery time of each processing circuit is determined according to the capacitance of the power supply wiring and the like, and can be acquired in advance. The information regarding the recovery time is prepared in advance, and the stop method determination unit 203 can be used as the circuit information of each processing circuit. In addition, information indicating whether or not each processing circuit is already in the stop state due to the power shut off is used to determine the recovery time. This information can be acquired from a past operation history, and the stop method determination unit 203 can be used as the circuit information of each processing circuit.

In addition, in the present embodiment, the processing circuit on which the power shut off is to be performed is selected such that the processing circuits in the power shut-off state are not adjacent to each other. As described above, in the present embodiment, the processing circuit on which the power shut off is to be performed is selected in consideration of an allowable amount of the recovery time and the physical arrangement of the plurality of processing circuits.

The temporal changes of the states of the processing circuits PA1 to PB4 will be described in chronological order with reference to FIGS. 3 and 4. At time t1, all the processing circuits PA1 to PB4 are in an operating state.

At time t2, the stop circuit determination unit 202 determines the processing circuits PA2, PB1, PB3, and PB4 as stop targets. Then, the stop method determination unit 203 determines a stop method for the processing circuits PA2, PB1, PB3, and PB4 such that the recovery time at the time of recovery from the power shut-off state becomes 4T or less. In the example of FIG. 4, the power shut off is applied to the processing circuits PA2, PB1, and PB4, and the clock gating is applied to the processing circuit PB3. Since the recovery time of the processing circuit PA2 is 2T and the recovery time of each of the processing circuits PB1 and PB4 is T, the recovery time when all the processing circuits PA2, PB1, and PB4 recover from the power shut-off state is 4T. Therefore, the condition that the recovery time is 4T or less is satisfied.

At time t3, the stop circuit determination unit 202 determines all the processing circuits PA1 to PB4 as stop targets. Then, similarly to time t2, the stop method determination unit 203 determines a stop method for the processing circuits PA1 to PB4 such that the recovery time is 4T or less. In the example of FIG. 4, the power shut off is applied to the processing circuits PA2, PB1, and PB4, and the clock gating is applied to the processing circuits PA1, PB2, and PB3. Similarly, in this situation, the condition that the recovery time is 4T or less is satisfied.

At time t4, the stop circuit determination unit 202 determines only the processing circuit PB2 as a stop target. Then, similarly to time t2, the stop method determination unit 203 determines a stop method for the processing circuit PB2 such that the recovery time is 4T or less. In the example of FIG. 4, the power shut off is applied to the processing circuit PB2. Since the recovery time of the processing circuit PB2 is T, the condition that the recovery time is 4T or less is satisfied.

Note that the processing circuits PA1, PA2, PB1, PB3, and PB4 transition from the stop state to the operating state between time t3 and time t4. In the processing circuits PA2, PB1, and PB4, the recovery from the power shut-off state is performed. Since the recovery time at this time is 4T and is equal to or less than the allowable value, the malfunction of the circuit is suppressed.

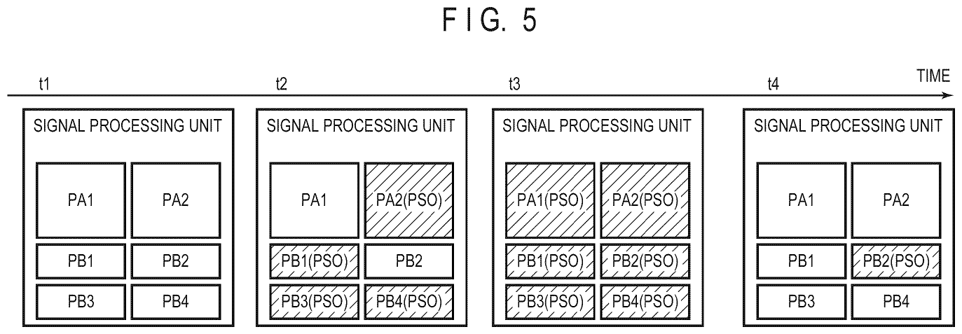

FIG. 5 is a schematic plan view illustrating a temporal change of a state of a processing circuit in a semiconductor device according to a comparative example. In FIG. 5, a difference from the example of FIG. 4 is that there is no restriction that the recovery time is 4T or less, and the power shut off is applied to all the processing circuits as stop targets. As illustrated in FIG. 5, at time t3, all the processing circuits PA1 to PB4 are in the power shut-off state.

In the example of FIG. 5, the processing circuits PA1, PA2, PB1, PB3, and PB4 recover from the power shut-off state between time t3 and time t4. The recovery time at this time is 7T, which exceeds the allowable value. Therefore, during the recovery from the power shut-off state, power supply voltages in the processing circuits PA1, PA2, PB1, PB3, and PB4 may not reach a predetermined voltage within a predetermined time, so that the malfunction of the circuit occurs. Alternatively, the malfunction of the circuit may occur due to the noise caused by a large inrush current flowing in the processing circuits PA1, PA2, PB1, PB3, and PB4. On the other hand, in the example of FIG. 4 of the present embodiment, the power shut off and the clock gating are selectively used for the plurality of processing circuits such that the recovery time does not exceed 4T which is the allowable value, thereby is suppressing the malfunction of the circuit due to the above-described factors.

As described above, the stop method determination unit 203 controls the stop method for the processing circuit such that the recovery time from the power shut-off state does not exceed the predetermined allowable value, whereby the recovery from the power shut-off state is appropriately performed while obtaining the power consumption reduction effect by stopping the processing circuit.

Furthermore, in the present embodiment, in the control of the stop method for the processing circuit, the physical arrangement of circuits including the processing circuit is considered in addition to the recovery time described above. As a result, the malfunction of the circuit can be more appropriately suppressed. Two examples of a method of considering the physical arrangement of the circuits including the processing circuit will be described.

As a first example of a method of considering the physical arrangement of the circuits including the processing circuit, a method of determining a combination of processing circuits to be shut off in consideration of the physical arrangement of a plurality of processing circuits will be described with reference to FIG. 4 again. This method is applied in the example illustrated in FIG. 4.

In the example at time t2 and time t3 in FIG. 4, the three processing circuits PA2, PB1, and PB4 in the power shut-off state are disposed at positions not adjacent to each other in a longitudinal direction and a lateral direction in plan view. As a result, the inrush current flowing through the power supply wiring when the processing circuits PA2, PB1, and PB4 recover from the power shut-off state is dispersed as compared with a case where the processing circuits subject to the power shut off are adjacent to each other. As a result, the noise caused by the inrush current can be reduced. In addition, since power can be supplied from different power supply terminals on the substrate to the processing circuits PA2, PB1, and PB4 that are not adjacent to each other, the recovery time from the power shut-off state can also be reduced.

As described above, when the processing circuit to be shut off is selected, it is desirable to select a combination of the processing circuits to be shut off such that a plurality of processing circuits to be in the power shut-off state are distant from each other. As a result, a large inrush current can be prevented from flowing locally, and the malfunction of the circuit can be further reduced. In addition, by selecting a combination of processing circuits to be shut off as described above, power can be supplied from different power supply terminals to a plurality of processing circuits, so that the recovery time from the power shut-off state can also be reduced. As a result, the malfunction of the circuit can be further reduced.

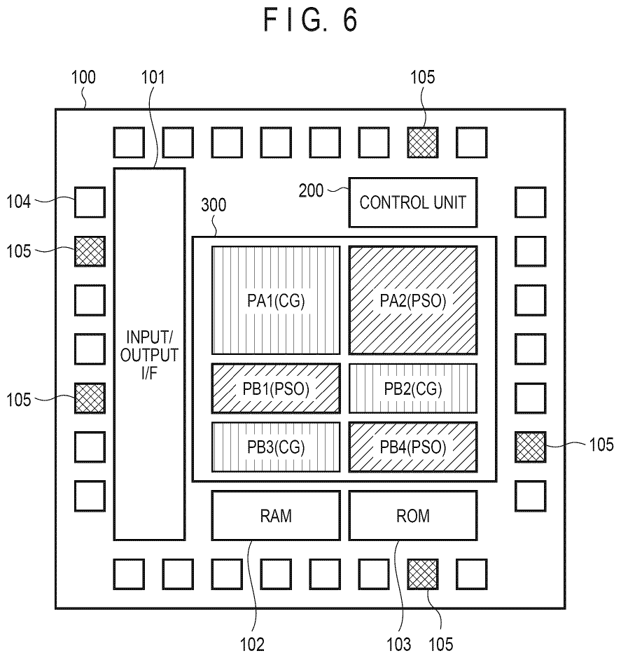

As a second example of a method of considering the physical arrangement of the circuits including the processing circuit, a method of determining a combination of processing circuits to be shut off in consideration of a positional relationship between a plurality of processing circuits and a power supply terminal on a substrate in which the plurality of processing circuits are formed will be described with reference to FIG. 6.

FIG. 6 is a schematic plan view illustrating physical arrangement on the semiconductor substrate in the semiconductor device 100 according to the present embodiment. FIG. 6 illustrates a plurality of pads 104 and 105 in addition to the configuration of the semiconductor device 100 illustrated in FIG. 2. The non-hatched pad 104 is a pad to which a signal wiring is connected, and the hatched pad 105 is a pad to which the power supply wiring is connected.

In addition, the boxes of the processing circuits PA1 to PB4 in FIG. 6 are hatched to indicate the stop state at time t3 in FIG. 4. That is, in the example of FIG. 6, all the processing circuits PA1 to PB4 are stop targets. Then, the power shut off is applied to the processing circuits PA2, PB1, and PB4, and the clock gating is applied to the processing circuits PA1, PB2, and PB3.

In the example of FIG. 6, the three processing circuits PA2, PB1, and PB4 in the power shut-off state are disposed at positions closer to the power supply pad 105 than other processing circuits in plan view. For example, when the processing circuit PA1 and the processing circuit PA2 are compared with each other, the processing circuit PA2 is disposed at a position closer to the pad 105 on the upper right. In addition, when the processing circuit PB2 and the processing circuit PB4 are compared with each other, the processing circuit PB4 is disposed at a position closer to two pads 105 on the lower right. As described above, in the example of FIG. 6, the processing circuits on which the power shut off is to be performed are selected so as to be in the power shut-off state in order from the processing circuit closest to the power supply pad 105 while satisfying the condition that the processing circuits in the power shut-off state are not adjacent to each other.

The closer the processing circuit is to the power supply pad 105, the smaller the impedance of the power supply wiring between the pad 105 and the processing circuit. Therefore, the closer the processing circuit is to the power supply pad 105, the shorter the time required for power recovery. Therefore, in a case where the processing circuits PA2, PB1, and PB4 are selected as power shut off targets, the time required for the recovery from the power shut off can be shortened as compared with, for example, a case where the processing circuits PA1, PB2, and PB3 are selected as power shut off targets. As a result, the malfunction of the circuit can be further reduced. Therefore, the malfunction of the circuit can be further reduced by determining the stop method such that the operation is preferentially stopped due to the power shut off as the processing circuit is closer to the power supply terminal.

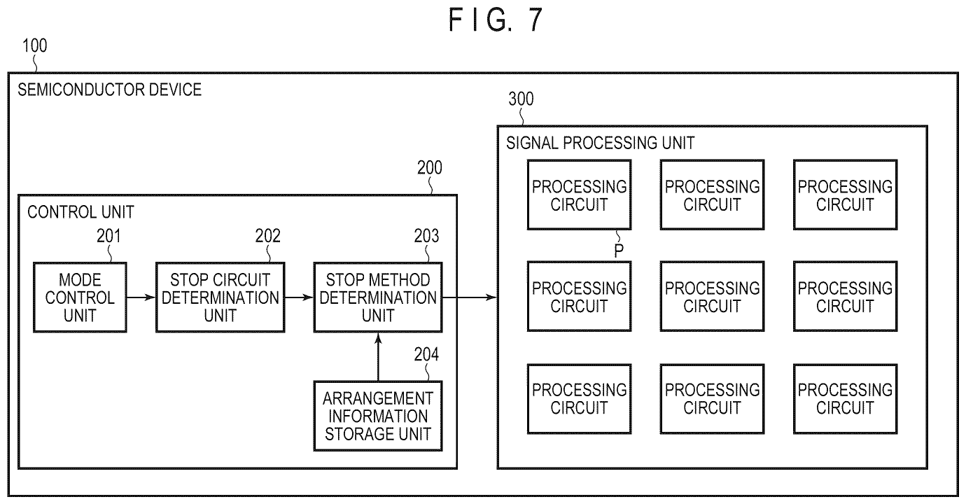

As described above, when the processing circuit to be shut off is selected, it is desirable to consider the physical arrangement of the circuits. A configuration example of the stop method determination unit 203 that realizes such selection will be described. FIG. 7 is a functional block diagram of the semiconductor device 100 according to a modification of the present embodiment. In FIG. 7, in addition to the configuration of FIG. 1, an arrangement information storage unit 204 is further disposed in the control unit 200.

The arrangement information storage unit 204 stores in advance arrangement information indicating physical arrangement of circuits including a processing circuit as an example of circuit information regarding a plurality of processing circuits. The arrangement information storage unit 204 includes a nonvolatile memory. This arrangement information is stored in the nonvolatile memory at the time of manufacturing the semiconductor device 100, and is not rewritten after shipment of the semiconductor device 100. The arrangement information storage unit 204 supplies the arrangement information to the stop method determination unit 203. The stop method determination unit 203 determines a stop method for the processing circuit by combining the information output from the stop circuit determination unit 202 and indicating whether or not the processing circuit is in the stop state and the arrangement information output from the arrangement information storage unit 204. Then, the stop method determination unit 203 outputs, to the processing circuit P to be stopped, a control signal for stopping an operation by the determined stop method. As a result, control in consideration of the physical arrangement of a plurality of processing circuits is performed.

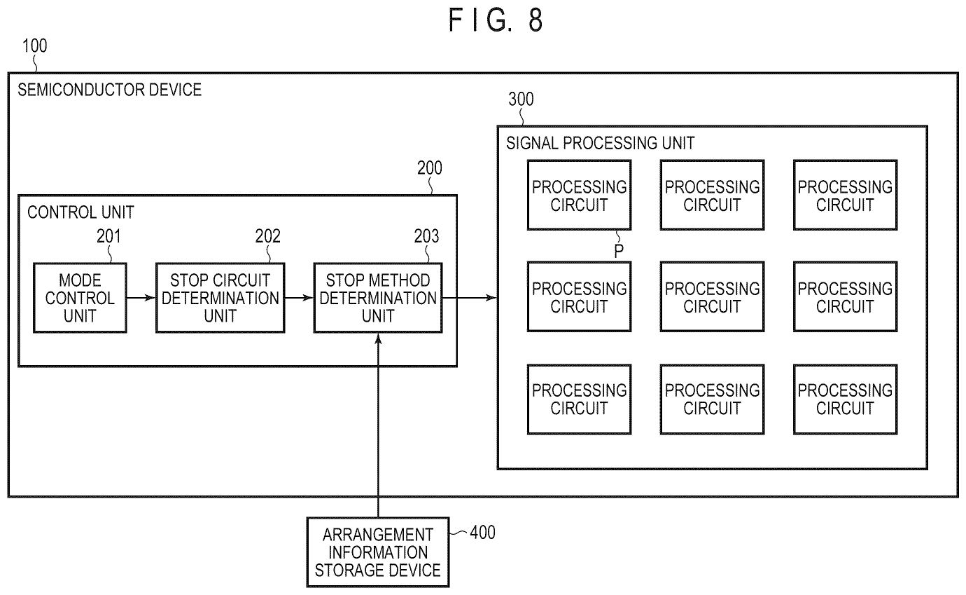

FIG. 8 is a functional block diagram of the semiconductor device 100 according to a modification of the present embodiment. In FIG. 8, an arrangement information storage device 400 having a function corresponding to the arrangement information storage unit 204 in FIG. 7 is disposed outside the semiconductor device 100. The arrangement information storage device 400 includes a nonvolatile memory that stores arrangement information and an interface that supplies the arrangement information to the semiconductor device 100. Similarly to the arrangement information storage unit 204, the arrangement information storage device 400 outputs the arrangement information to the stop method determination unit 203. As described above, the arrangement information may be stored in a device outside the semiconductor device 100.

As described above, according to the present embodiment, there is provided the semiconductor device capable of more appropriately recovering from the power shut-off state.

### Second Embodiment

A control method of the processing circuit in the semiconductor device 100 of the first embodiment can be applied to various devices having a plurality of processing circuits. In the present embodiment, an example will be described in which the control method of the processing circuit of the first embodiment is applied to a photoelectric conversion device such as an imaging device. In the present embodiment, the description of elements common to the first embodiment may be omitted or simplified.

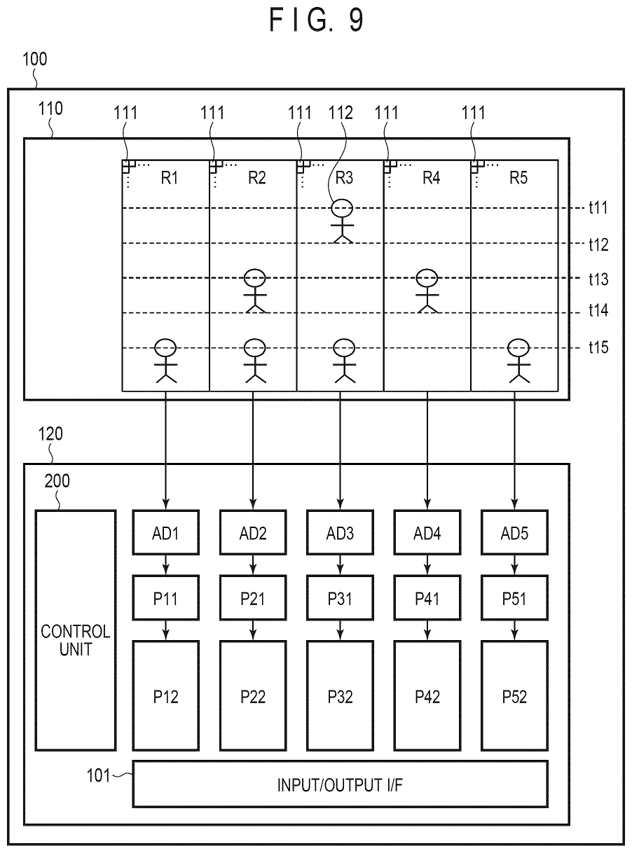

FIG. 9 is a block diagram of the semiconductor device 100 according to the present embodiment. The semiconductor device 100 according to the present embodiment is a stacked-type photoelectric conversion device in which a light receiving element layer 110 and a signal processing circuit layer 120 are stacked. This structure can be manufactured, for example, by stacking a first substrate in which the light receiving element layer 110 is formed and a second substrate in which the signal processing circuit layer 120 is formed. Note that the structure of the semiconductor device 100 according to the present embodiment is not limited to the stacked structure, and may be a single-layer structure. In this case, a circuit having the function of the light receiving element layer 110 and the function of the signal processing circuit layer 120 is formed on one substrate.

In the light receiving element layer 110, a plurality of light receiving elements 111 disposed to form a plurality of rows and a plurality of columns are disposed. The light receiving element 111 includes a photoelectric conversion element such as a photodiode, and photoelectrically converts incident light to generate a pixel signal. A pixel region where the plurality of light receiving elements 111 is disposed is divided into five regions R1 to R5. The semiconductor device 100 according to the present embodiment has a function of outputting image information of a region selected from the five regions R1 to R5 based on a detection result of an object 112.

In the signal processing circuit layer 120, a circuit that performs signal processing on the pixel signals output from the plurality of light receiving elements 111 is disposed. In the signal processing circuit layer 120, a control unit 200 and an input/output I/F 101 are disposed. In addition, five analog-to-digital conversion circuits (AD conversion circuits) AD1 to AD5, five processing circuits P11 to P51, and five processing circuits P12 to P52 are disposed in the signal processing circuit layer 120 so as to correspond to the five regions R1 to R5, respectively. An analog signal output from the light receiving element 111 in the region R1 is converted into a digital signal in the AD conversion circuit AD1, and the converted digital signal is input to the processing circuit P11 and then input to the processing circuit P12. Analog signals output from the light receiving elements 111 in the regions R2 to R5 are similarly input to the corresponding AD conversion circuits and processing circuits.

In the present embodiment, it is assumed that the five processing circuits P11, P21, P31, P41, and P51 have the same function. In addition, it is assumed that the five processing circuits P12, P22, P32, P42, and P52 also have the same function. In this case, since the five processing circuits P12, P22, P32, P42, and P52 have substantially the same capacitance of the power supply wiring, the time required for the recovery from the power shut-off state is substantially the same.

The control unit 200 controls the entire semiconductor device 100. In addition, similarly to the first embodiment, the control unit 200 has a function of determining a processing circuit to be stopped and a function of determining a stop method in the processing circuit to be stopped.

As described above, each of the AD conversion circuits AD1 to AD5 has a function of converting an input analog signal into a digital signal. However, in a case where the light receiving element 111 can output a digital signal, the AD conversion circuits AD1 to AD5 may not be disposed. For example, in a case where the light receiving element 111 is a single photon avalanche diode (SPAD) sensor and has a function of counting incident photons and outputting a digital signal, the AD conversion circuits AD1 to AD5 are omitted.

Each of the processing circuits P11 to P51 processes the input pixel signal to detect the object 112. Each of the processing circuits P12 to P52 processes the pixel signal in a case where the corresponding processing circuit P11 to P51 detect the object 112, and generates image information of the corresponding region. The generated image information is output to the outside of the semiconductor device 100 via the input/output I/F 101. On the other hand, in a case where the processing circuits P11 to P51 do not detect the object 112, the corresponding processing circuits P12 to P52 stop the operation. As described above, in the present embodiment, an operation of a processing circuit other than the processing circuit corresponding to the region in which the object 112 is detected is stopped. The method of stopping the operation in each of the processing circuits P12 to P52 at this time can be selected one of the power shut off and the clock gating as in the first embodiment.

A plurality of light receiving elements 111 are scanned row by row in order from the uppermost row in FIG. 9. In FIG. 9, “t11” to “t15” indicate times at which rows at the illustrated positions are scanned.

At time t11, the object 112 is detected only in the region R3. Therefore, the processing circuit P32 corresponding to the region R3 performs a signal processing operation, and the processing circuits P12, P22, P42, and P52 stop the operation.

At time t12, the object 112 is not detected in any region. Therefore, the processing circuits P12, P22, P32, P42, and P52 stop the operation.

At time t13, the object 112 is detected in the regions R2 and R4. Therefore, the processing circuits P22 and P42 corresponding to the regions R2 and R4 perform the signal processing operation, and the processing circuits P12, P32, and P52 stop the operation.

At time t14, the object 112 is not detected in any region. Therefore, the processing circuits P12, P22, P32, P42, and P52 stop the operation.

At time t15, the object 112 is detected in the regions R1, R2, R3, and R5. Therefore, the processing circuits P12, P22, P32, and P52 respectively corresponding to the regions R1, R2, R3, and R5 perform the signal processing operation, and the processing circuit P42 stops the operation.

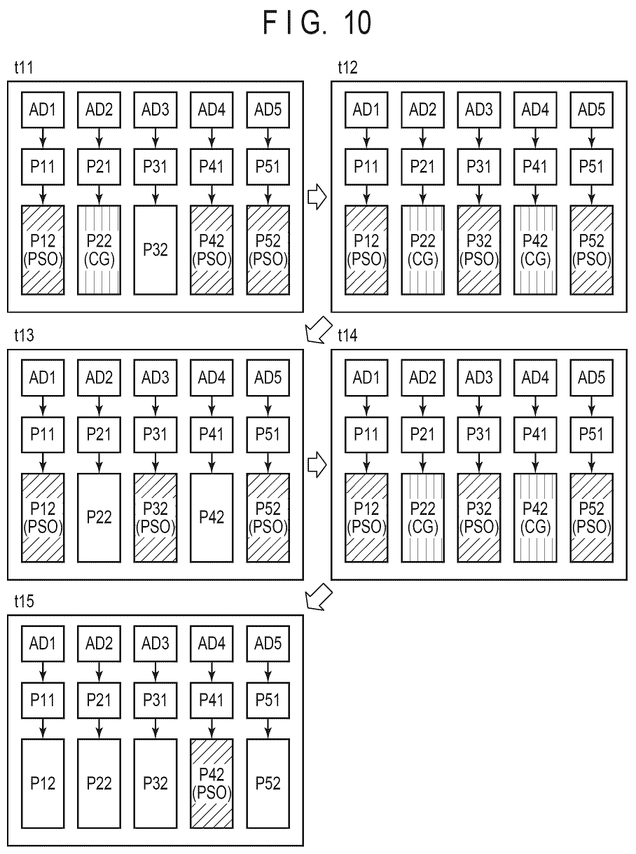

FIG. 10 is a schematic diagram illustrating the temporal change of the state of the processing circuit in the semiconductor device 100 according to the present embodiment. FIG. 10 schematically illustrates the temporal changes of the states of the processing circuits P12 to P52 from time t11 to time t15. Boxes indicating the processing circuits in the operating state are not hatched. Hatching similar to that in FIG. 4 is applied to the box indicating the processing circuit that is in the stop state due to either the power shut off or the clock gating.

In the first embodiment, an example is described in which the recovery times from the power shut-off state are not the same in the plurality of processing circuits. However, the processing circuits P12 to P52 of the present embodiment have the same function, so that the recovery times of the processing circuits P12 to P52 from the power shut-off state are the same. In this case, the entire recovery time of the processing circuits P12 to P52 from the power shut-off state depends on the number of processing circuits that recover from the power shut-off state. In the present embodiment, the temporal change in FIG. 10 will be described assuming that there is a constraint that the upper limit value of the number of the processing circuits that can be simultaneously recovered from the power shut-off state is three.

At time t11, the object 112 is detected only in the region R3 as described above, and thus, the processing circuits P12, P22, P42, and P52 other than the processing circuit P32 stop the operation. Here, the power shut off is applied to the processing circuits P12, P42, and P52, and the clock gating is applied to the processing circuit P22.

At time t12, the object 112 is not detected in any region as described above, and thus the processing circuits P12, P22, P32, P42, and P52 stop the operation. Here, the power shut off is applied to the processing circuits P12, P32, and P52, and the clock gating is applied to the processing circuits P22 and P42.

At time t13, the object 112 is detected in the regions R2 and R4 as described above, and thus, the processing circuits P22 and P42 other than the processing circuits P12, P32, and P52 stop the operation. Here, the power shut off is applied to the processing circuits P12, P32, and P52.

At time t14, the object 112 is not detected in any region as described above, and thus the processing circuits P12, P22, P32, P42, and P52 stop the operation. Here, the power shut off is applied to the processing circuits P12, P32, and P52, and the clock gating is applied to the processing circuits P22 and P42.

At time t15, the object 112 is detected in the regions R1, R2, R3, and R5 as described above, and thus, the processing circuits P42 other than the processing circuits P12, P22, P32, and P52 stop the operation. Here, the power shut off is applied to the processing circuit P42.

As described above, in the present embodiment, the stop method for the processing circuit is controlled such that the number of processing circuits that are in the power shut-off state at each time is three or less. Effects of the present embodiment will be described focusing on transition from the state at time t14 to the state at time t15.

Assuming that all the processing circuits are in the power shut-off state at time t14, the number of processing circuits that recover from the power shut-off state at the time of transition from the state at time t14 to the state at time t15 is four. Therefore, since the number of processing circuits that simultaneously recover from the power shut-off state exceeds the upper limit value of three, the malfunction of the circuit may occur. On the other hand, in the present embodiment, at the time of transition from time t14 to time t15, the number of processing circuits that recover from the power shut-off state is three, and does not exceed the upper limit value, so that the malfunction of the circuit is suppressed.

As described above, the stop method for the processing circuit is controlled such that the number of processing circuits that simultaneously recover from the power shut-off state does not exceed a predetermined allowable value, whereby the recovery from the power shut-off state is appropriately performed while obtaining the power consumption reduction effect by stopping the processing circuit.

In addition, at times t12 and t14, a combination of processing circuits to be shut off is determined in consideration of the physical arrangement of the plurality of processing circuits as described in the first embodiment. More specifically, the clock gating is applied to a processing circuit among a plurality of processing circuits in the power shut-off state, and the plurality of processing circuits in the power shut-off state are separated from each other. As a result, malfunction of the circuit can be further reduced for the same reason as described in the first embodiment.

As described above, according to the present embodiment, there is provided the photoelectric conversion device to which the method capable of more appropriately recovering from the power shut-off state is applied.

### Third Embodiment

In the present embodiment, another example of the photoelectric conversion device to which the processing circuit control method of the first embodiment is applied will be described. In the present embodiment, the description of elements common to the first embodiment or the second embodiment may be omitted or simplified.

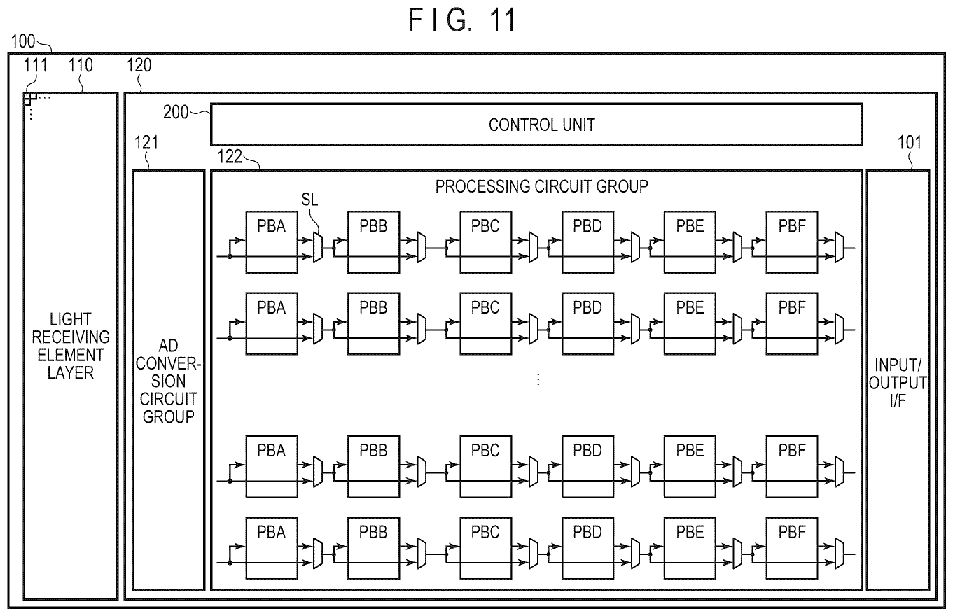

FIG. 11 is a block diagram of the semiconductor device 100 according to the present embodiment. The semiconductor device 100 according to the present embodiment is a stacked-type photoelectric conversion device in which the light receiving element layer 110 and the signal processing circuit layer 120 are stacked as in the second embodiment. However, the structure of the semiconductor device 100 according to the present embodiment is not limited to the stacked structure, and may be a single-layer structure. In the light receiving element layer 110, similarly to the second embodiment, the plurality of light receiving elements 111 disposed to form a plurality of rows and a plurality of columns are disposed.

In the signal processing circuit layer 120, a circuit that performs signal processing on the pixel signals output from the plurality of light receiving elements 111 is disposed. As illustrated in FIG. 11, the signal processing circuit layer 120 includes an AD conversion circuit group 121, a processing circuit group 122, the control unit 200, and the input/output I/F 101.

The AD conversion circuit group 121 includes a plurality of AD conversion circuits. Each of the plurality of AD conversion circuits converts an analog signal output from the light receiving element 111 into a digital signal and outputs the digital signal to the processing circuit group 122. However, in a case where the light receiving element 111 can output a digital signal, the AD conversion circuit group may not be disposed. For example, in a case where the light receiving element 111 is a SPAD sensor, counts incident photons, and outputs a digital signal, the AD conversion circuit group is unnecessary.

The processing circuit group 122 includes six processing circuits PBA, PBB, PBC, PBD, PBE, and PBF disposed in series. The six processing circuits PBA, PBB, PBC, PBD, PBE, and PBF are signal processing circuits that sequentially perform various types of signal processing such as noise subtraction, shading correction, and gain adjustment. In addition, in order to process a plurality of signals input from the AD conversion circuit group 121 in parallel, a plurality of sets of the above-described six processing blocks are disposed in parallel.

A selector SL is disposed at the subsequent stage of the processing circuit PBA and the preceding stage of the processing circuit PBB. The selector SL selectively outputs either an input signal to the processing circuit PBA or an output signal of the processing circuit PBA to the processing circuit PBB according to a control signal from the control unit 200. As a result, the selector SL can select whether or not to skip the signal processing in the processing circuit PBA. Similarly, the selector SL is disposed at each of the subsequent stages of the processing circuits PBB, PBC, PBD, PBE, and PBF. These selectors SL can select whether or not to skip the signal processing in the processing circuits PBB, PBC, PBD, PBE, and PBF.

In a case where the processing in each of the processing circuits PBA to PBF is skipped, the operation of the corresponding processing circuit is unnecessary, so that the operation is stopped by the power shut off or the clock gating. The control unit 200 has a function of determining a processing circuit to be stopped and a function of determining a stop method in the processing circuit to be stopped, in addition to the control of the entire semiconductor device 100. The operation stop processing described in the first embodiment and the second embodiment can also be applied to the control for stopping the operation of the processing circuit of the present embodiment.

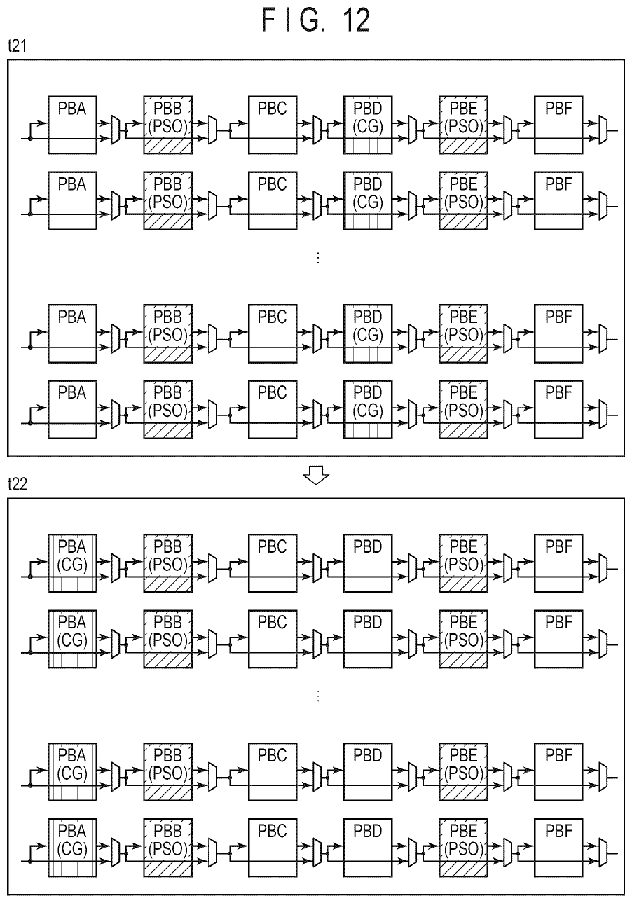

FIG. 12 is a schematic diagram illustrating the temporal change of the state of the processing circuit in the semiconductor device 100 according to the present embodiment. FIG. 12 schematically illustrates the temporal changes of the states of the processing circuits PBA to PBF from time t21 to time t22. Boxes indicating the processing circuits in the operating state are not hatched. Hatching similar to that in FIGS. 4 and 10 is applied to the box indicating the processing circuit that is in the stop state due to either the power shut off or the clock gating.

Although the processing circuits PBA to PBF of the present embodiment have different functions, it is assumed that the recovery times of the processing circuits PBA to PBF from the power shut-off state are the same. In this case, the entire recovery time of the processing circuits PBA to PBF from the power shut-off state depends on the number of processing circuits that recover from the power shut-off state. In the present embodiment, the temporal change in FIG. 12 will be described assuming that there is a constraint that the upper limit value of the number of the processing circuits that can be simultaneously recovered from the power shut-off state is two.

At time t21, the processing circuits PBB, PBD, and PBE stop the operation. Here, the power shut off is applied to the processing circuits PBB and PBE, and the clock gating is applied to the processing circuit PBD.

At time t22, the processing circuits PBA, PBB, and PBE stop the operation. Here, the power shut off is applied to the processing circuits PBB and PBE, and the clock gating is applied to the processing circuit PBA.

As described above, in the present embodiment, the stop method for the processing circuit is controlled such that the number of processing circuits that are in the power shut-off state at each time is two or less. As described above, the stop method for the processing circuit is controlled such that the number of processing circuits that simultaneously recover from the power shut-off state does not exceed a predetermined allowable value, whereby the recovery from the power shut-off state is appropriately performed while obtaining the power consumption reduction effect by stopping the processing circuit.

In addition, in the present embodiment, the stop method is selected such that the processing circuits PBB and PBE are maintained in the power shut-off state between time t21 and time t22. Then, the clock gating is applied to the processing circuits PBA and PBD the states of which change between time t21 and time t22. These effects will be described.

When the stop method for the processing circuit transitions from the power shut off to the clock gating, the voltage supplied to the processing circuit changes, so that an inrush current occurs. Electric power is also consumed when the inrush current flows. Therefore, for processing circuits, such as the processing circuits PBB and PBE of the present embodiment, in which the stop state continues for two periods, in a case where an original state is the power shut-off state, the power consumption can be reduced by selecting the stop method such that the power shut-off state continues. As described above, when the states of the plurality of processing circuits transition, a combination of processing circuits to be shut off may be determined in consideration of the state before the transition.

As described above, according to the present embodiment, there is provided the photoelectric conversion device to which the method capable of more appropriately recovering from the power shut-off state is applied.

### Fourth Embodiment

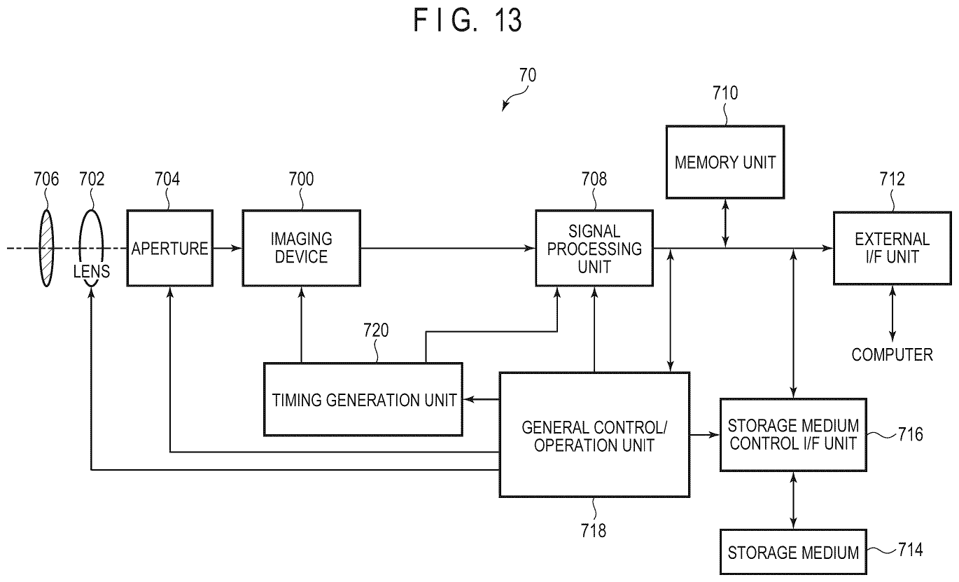

The semiconductor device 100 of the above embodiments can be applied to various equipment. Examples of the equipment include a digital still camera, a digital camcorder, a camera head, a copying machine, a facsimile, a mobile phone, a vehicle-mounted camera, an observation satellite, and a surveillance camera. FIG. 13 is a block diagram of a digital still camera as an example of equipment. FIG. 13 illustrates an example in which the semiconductor device 100 of the above embodiments is applied to a digital still camera.

The equipment 70 illustrated in FIG. 13 includes a barrier 706, a lens 702, an aperture 704, and an imaging device 700 (an example of the semiconductor device or the photoelectric conversion device). The equipment 70 further includes a signal processing unit (processing device) 708, a timing generation unit 720, a general control/operation unit 718 (control device), a memory unit 710 (storage device), a storage medium control I/F unit 716, a storage medium 714, and an external I/F unit 712. The semiconductor device 100 of the above-described embodiments may be included in the imaging device 700 or may be included in the signal processing unit 708. At least one of the barrier 706, the lens 702, and the aperture 704 is an optical device corresponding to the equipment. The barrier 706 protects the lens 702, and the lens 702 forms an optical image of an object on the imaging device 700. The aperture 704 varies the amount of light passing through the lens 702. The imaging device 700 is configured as in the above embodiments, and converts an optical image formed by the lens 702 into image data (image signal). The signal processing unit 708 performs various corrections, data compression, and the like on the image data output from the imaging device 700. The timing generation unit 720 outputs various timing signals to the imaging device 700 and the signal processing unit 708. The general control/operation unit 718 controls the entire digital still camera, and the memory unit 710 temporarily stores image data. The storage medium control I/F unit 716 is an interface for storing or reading image data on the storage medium 714, and the storage medium 714 is a detachable storage medium such as a semiconductor memory for storing or reading image data. The external I/F unit 712 is an interface for communicating with an external computer or the like. The timing signal or the like may be input from the outside of the equipment. The equipment 70 may further include a display device (a monitor, an electronic view finder, or the like) for displaying information obtained by the imaging device 700. The equipment includes at least a photoelectric conversion device. Further, the equipment 70 includes at least one of an optical device, a control device, a processing device, a display device, a storage device, and a mechanical device that operates based on information obtained by the photoelectric conversion device. The mechanical device is a movable portion (for example, a robot arm) that receives a signal from the photoelectric conversion device for operation.

Each pixel may include a plurality of photoelectric conversion units (a first photoelectric conversion unit and a second photoelectric conversion unit). The signal processing unit 708 may be configured to process a pixel signal based on charges generated in the first photoelectric conversion unit and a pixel signal based on charges generated in the second photoelectric conversion unit, and acquire distance information from the imaging device 700 to an object.

### Fifth Embodiment

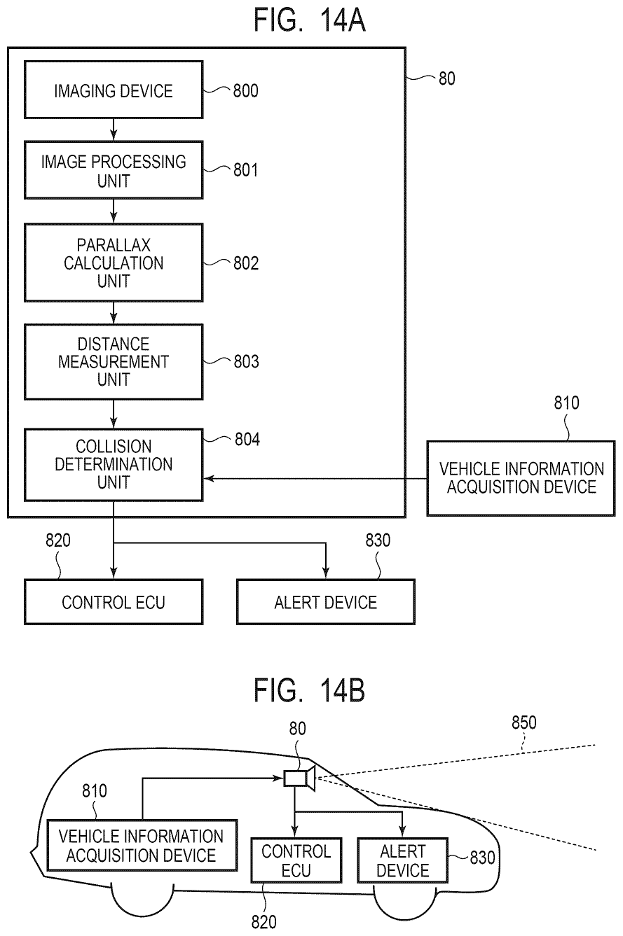

FIGS. 14A and 14B are block diagrams of equipment relating to the vehicle-mounted camera according to the present embodiment. FIGS. 14A and 14B illustrate an example in which the semiconductor device 100 of the above embodiments is applied to a movable body such as a vehicle. The equipment 80 includes an imaging device 800 (an example of the semiconductor device 100 or a photoelectric conversion device) and a signal processing device (processing device) that processes a signal from the imaging device 800. The equipment 80 includes an image processing unit 801 that performs image processing on a plurality of pieces of image data acquired by the imaging device 800, and a parallax calculation unit 802 that calculates parallax (phase difference of parallax images) from the plurality of pieces of image data acquired by the equipment 80. The information processing device 30 of the above-described embodiments may be included in the imaging device 800 or may be included in the image processing unit 801. The equipment 80 includes a distance measurement unit 803 that calculates a distance to an object based on the calculated parallax, and a collision determination unit 804 that determines whether or not there is a possibility of collision based on the calculated distance. Here, the parallax calculation unit 802 and the distance measurement unit 803 are examples of a distance information acquisition unit that acquires distance information to the object. That is, the distance information is information on a parallax, a defocus amount, a distance to the object, and the like. The collision determination unit 804 may determine the possibility of collision using any of these pieces of distance information. The distance information acquisition unit may be realized by dedicatedly designed hardware or software modules. Further, it may be realized by a field programmable gate array (FPGA), an application specific integrated circuit (ASIC) or a combination thereof.

The equipment 80 is connected to the vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm such as a sound, displaying alert information on a screen of a car navigation system or the like, or giving vibration to a seat belt or a steering wheel. The equipment 80 functions as a control unit that controls the operation of controlling the vehicle as described above.

In the present embodiment, an image of the periphery of the vehicle, for example, the front or the rear is captured by the equipment 80. FIG. 14B illustrates equipment in a case where an image is captured in front of the vehicle (image capturing range 850). The vehicle information acquisition device 810 as the imaging control unit sends an instruction to the equipment 80 or the imaging device 800 to perform the imaging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The present invention is not limited to the above embodiments, and various modifications are possible. For example, an example in which some of the configurations of any one of the embodiments are added to other embodiments or an example in which some of the configurations of any one of the embodiments are replaced with some of the configurations of other embodiments are also embodiments of the present invention.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A≠B) is omitted. This is because it is assumed that “A is not B” is considered when “A is B” is described.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that any of the embodiments described above is merely an example of an embodiment for carrying out the present invention, and the technical scope of the present invention should not be construed as being limited by the embodiments. That is, the present invention can be implemented in various forms without departing from the technical idea or the main features thereof.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-042122, filed Mar. 18, 2024, which is hereby incorporated by reference herein in its entirety.

What is claimed is:

1. A semiconductor device comprising:
a plurality of processing circuits;
a stop circuit determination unit configured to determine a first processing circuit an operation of which is to be stopped from among the plurality of processing circuits; and
a stop method determination unit configured to determine a stop method for the operation in the first processing circuit to be either a first stop method including power shut off or a second stop method not including power shut off, based on circuit information of each of the first processing circuit and a second processing circuit different from the first processing circuit among the plurality of processing circuits,
wherein the stop method determination unit determines the stop method such that a load impedance of a processing circuit, which is in a stop state at a same time due to the first stop method, among the plurality of processing circuits, as seen from a power supply wiring side is equal to or greater than a predetermined impedance.

2. The semiconductor device according to claim 1, wherein the circuit information includes information indicating whether or not a processing circuit corresponding to the circuit information is already in the stop state due to the first stop method.

3. The semiconductor device according to claim 1, wherein the circuit information includes information indicating arrangement of circuits including a processing circuit corresponding to the circuit information.

4. The semiconductor device according to claim 3, wherein the circuit information further includes information indicating a positional relationship between the processing circuit corresponding to the circuit information and a power supply terminal on a substrate in which the plurality of processing circuits are formed.

5. The semiconductor device according to claim 4, wherein the stop method determination unit determines the stop method such that an operation of a processing circuit closest to the power supply terminal is stopped by the first stop method.

6. The semiconductor device according to claim 3, wherein the stop circuit determination unit determines the stop method such that a plurality of processing circuits, which are in the stop state by the first stop method, among the plurality of processing circuits are not adjacent to each other in plan view with respect to a substrate in which the plurality of processing circuits are disposed.

7. The semiconductor device according to claim 1 further comprising a storage unit configured to store the circuit information of each of the plurality of processing circuits,
wherein the stop method determination unit acquires the circuit information from the storage unit.

8. The semiconductor device according to claim 1, wherein the stop method determination unit acquires the circuit information from a device outside the semiconductor device.

9. The semiconductor device according to claim 1, wherein a recovery time of a processing circuit which is in the stop state by the second stop method is shorter than a recovery time of a processing circuit which is in the stop state by the first stop method.

10. The semiconductor device according to claim 1, wherein power consumption of a processing circuit in the stop state by the second stop method is larger than power consumption of a processing circuit in the stop state by the first stop method.

11. The semiconductor device according to claim 1, wherein the second stop method includes clock gating.

12. The semiconductor device according to claim 1, wherein the plurality of processing circuits process pixel signals based on outputs of a plurality of photoelectric conversion elements.

13. The semiconductor device according to claim 12, wherein the plurality of processing circuits have a same function.

14. The semiconductor device according to claim 12,
wherein a region in which the plurality of photoelectric conversion elements are disposed is divided into a plurality of regions, and
wherein a pixel signal generated in each of the plurality of regions is processed by a corresponding one of the plurality of processing circuits.

15. The semiconductor device according to claim 14, wherein the stop circuit determination unit determines, as the first processing circuit, a processing circuit, which is other than a processing circuit corresponding to a region determined based on the pixel signal, among the plurality of processing circuits.

16. The semiconductor device according to claim 14, wherein the stop circuit determination unit determines, as the first processing circuit, a processing circuit, which is other than a processing circuit corresponding to a region in which an object is detected based on the pixel signal, among the plurality of processing circuits.

17. The semiconductor device according to claim 12,
wherein the plurality of processing circuits processes the pixel signals in series,
wherein the plurality of processing circuits are configured such that operations of some processing circuits are skippable, and
wherein the stop circuit determination unit determines, as the first processing circuit, a processing circuit the operation of which is skipped among the plurality of processing circuits.

18. A semiconductor device comprising:
a plurality of processing circuits;
a stop circuit determination unit configured to determine a first processing circuit an operation of which is to be stopped from among the plurality of processing circuits; and
a stop method determination configured to determine a stop method for the operation in the first processing circuit to be either a first stop method including power shut off or a second stop method not including power shut off, based on circuit information of each of the first processing circuit and a second processing circuit different from the first processing circuit among the plurality of processing circuits,
wherein the stop method determination unit determines the stop method such that the number of processing circuits, which are in a stop state at a same time due to the first stop method, among the plurality of processing circuits is equal to or less than a threshold.

19. Equipment comprising:
a photoelectric conversion device including the semiconductor device according to claim 1; and
at least any one of:
an optical device adapted for the photoelectric conversion device,
a control device configured to control the photoelectric conversion device,
a processing device configured to process a signal output from the photoelectric conversion device,
a display device configured to display information obtained by the photoelectric conversion device,
a storage device configured to store information obtained by the photoelectric conversion device, and
a mechanical device configured to operate based on information obtained by the photoelectric conversion device.

20. The equipment according to claim 19, wherein the processing device acquires distance information on a distance from the photoelectric conversion device to an object.

21. Equipment comprising:
a photoelectric conversion device including the semiconductor device according to claim 18; and
at least any one of:
an optical device adapted for the photoelectric conversion device,
a control device configured to control the photoelectric conversion device,
a processing device configured to process a signal output from the photoelectric conversion device,
a display device configured to display information obtained by the photoelectric conversion device,
a storage device configured to store information obtained by the photoelectric conversion device, and
a mechanical device configured to operate based on information obtained by the photoelectric conversion device.

22. The equipment according to claim 21, wherein the processing device acquires distance information on a distance from the photoelectric conversion device to an object.
